(19) United States
(12) Patent Application Publication
(10) Pub. No.: US 2022/0012991 A1
(43) Pub. Date: Jan. 13, 2022

(54) DUAL DOMED BROAD BAND SENSORY STIMULATION DRIVER

(71) Applicant: Thomas Clark Fenner, JR., Littleton, CO (US)

(72) Inventor: Thomas Clark Fenner, JR., Littleton, CO (US)

(21) Appl. No.: 16/926,775

(22) Filed: Jul. 13, 2020

(51) Int. Cl. G08B 6/00; H04R 3/00

(52) U.S. Cl. CPC G08B 6/00; H04R 3/00

(57) ABSTRACT

A dual dome, coil-driven sensory stimulation apparatus to provide vibration synchronized with a soundtrack to a listener. An amplifier can receive electrical signals from a sound generator and can apply an electrical signal to one or more drivers. Each driver is electrically connected to the amplifier and has a driving magnet, toroidal pole pieces, and a voice coil. The driver can be mounted to furniture or underwater. The use of rare earth magnetic material provides broad band frequency response, high fidelity tactile, haptic, kinesthetic, and bone conductive sensory stimulation with a high G force output.

### RELATED PATENTS AND APPLICATIONS

The present application is related to U.S. Pat. No. 4,757, 548 issued to Thomas C. Fenner, Jr., U.S. Pat No. 5,473,700 issued to Thomas C. Fenner Jr., and copending U.S. provisional patent application No. 62/873,125, filed Jun. 11, 2019 on application of Thomas C. Fenner, Jr. the disclosures of which are hereby specifically incorporated herein by reference.

### FIELD OF THE INVENTION

The present invention pertains to sensory stimulation devices and, more particularly, to a sensory stimulation driver apparatus for providing vibration synchronized with a soundtrack to a viewer or listener.

### BACKGROUND OF THE INVENTION

Sensory stimulation for entertainment has existed for more than 100 years in the form of auditory and visual sensation. The addition of sound in movies brought us closer to achieving the “suspension of disbelief” as a perceived goal of movie producers. Since then, the progression of visual reproduction has improved greatly as has the implementation of “surround sound” with the addition of multiple speaker sets to improve audio spatial separation.

Many efforts have been made to add additional sensory stimuli including olfactory cues and even wind. Other efforts have been made to reproduce the physical sensation of sound, typically by adding large speakers or sub woofers to audio and visual productions.

Over the last 30 years certain devices have been devised to re-create the physical aspect of sound by reproducing the vibrations via a bass shaker or tactile sound transducer. In most cases a transducer is attached to furniture to impart the vibration directly to the solid mass of a couch, chair or in some instances a floor riser underneath the furniture. Most of these shakers and transducers are limited in frequency bandwidth and concentrate primarily on reproducing only low frequencies.

Transducers capable of converting energy between mechanical and electrical form have many uses. Transducers operative to convert electrical energy into mechanical energy include conventional speakers as well as transducers capable of generating high energy vibration. A brief summary of related art is listed below.

### DESCRIPTION OF RELATED ART

U.S. Pat. No. 5,473,700 issued to the present applicant, Thomas Clark Fenner, Jr. on Dec. 5, 1995 for HIGH GAIN ACOUSTIC TRANSDUCER describes a high gain acoustic transducer formed of a voice coil and a magnetic material housed within a transducer housing. The transducer housing includes two symmetrical dome halves formed of a flexible material. Vibrations of the transducer induce a current in the voice coil as the magnetic material is caused to translate relative to the voice coil. Alternatively, electrical signals applied to the voice coil induce vibrations in the transducer. The voice coil is supported by a first of the two dome halves by way of a first support assembly, and the magnetic material is supported by a second of the two dome halves by way of a second support assembly. The first and second support assemblies are positioned against similarly-dimensioned portions of the first and second dome halves, respectively. Resonating surfaces of the two dome halves are of substantially similar dimensions. The housing forms a watertight enclosure, and the transducer may be utilized in underwater applications.

U.S. Pat. No. 7,079,995 issued to Buttafoco on Jul. 18, 2006 for TACTILE SIMULATOR FOR USE IN CONJUNCTION WITH A VIDEO DISPLAY describes a tactile simulator for use in conjunction with a video display. The tactile simulator comprises a tactile bar, and a video program player capable of generating audio, video, and control outputs upon reading a video medium having encoded simulation control information. The signals which are transmitted to the tactile bar by the video program player control the motion of weights located within the tactile bar, vibration of motors within the tactile bar, and temperature changes of the tactile bar. Two motors having eccentric weights cause the tactile bar to selectively vibrate. Additionally, the movement of the weights within the tactile bar imparts a sense of motion.

U.S. Pat. No. 5,669,818 issued to Thorner, et al. on Sep. 23, 1997 for SEAT-BASED TACTILE SENSATION GENERATOR describes a seat-based tactile sensation generator capable of producing tactile sensation to a video game player corresponding to activity portrayed in a video game. In response to signals produced by the video game, a control circuit generator produces control signals for the seat-based tactile sensation generator. The tactile sensation generator contains an array of actuators embedded within a foam seating pad. A specific arrangement of actuators positions the actuators proximate particular portions of a game player's body. Each actuator or group of actuators interacts with the player and is individually activated to produce a localized tactile sensation (e.g., an impact or vibration) corresponding to the action portrayed by the video game as it occurs.

U.S. Pat. No. 5,553,148 issued to Werle on Sep. 3, 1996 for APPARATUS AND METHOD FOR PRODUCING VIBRATORY SENSATIONS TO ACCOMPANY AUDIBLE SOUNDS IN A PROPERLY PHASED RELATIONSHIP describes a system and method for producing vibratory sensations on a listener's body which are similar to those experienced during a live performance, both in their vibratory nature and in their properly synchronized timing with the audible sounds which the listener is hearing at any given moment. The vibrations are imparted to the body of the listener by using a gel pack interposed between the body of the listener and a rigid or semi-rigid member on which a surface transducer is mounted, thereby providing an enhanced degree of coupling between the surface transducer and a relatively large area of the listener's body. The propagation of vibrations to the body of the listener is delayed using electronic circuitry interposed between a source of electronic signals and the surface transducer to allow the sound waves from a speaker to reach the ears of the listener at the same time that the vibrations are provided to the body of the listener.

### SUMMARY OF THE INVENTION

The present invention is a dual dome, coil driven sensory stimulation device or apparatus to provide vibration synchronized with a soundtrack to a listener. An amplifier can receive electrical signals from a sound generator and can apply an electrical signal to one or more drivers. Each driver is electrically connected to the amplifier and has an audio coil excited by a magnet assembly comprising neodymium cylindrical magnets and low carbon toroidal pole pieces. Current magnetic assemblies have been measured to 1.5 Tesla of magnetic strength. The driver can be directly mounted to furniture utilizing the neodymium mounting magnet and then magnetically attached to ferrous support structures or via countersunk hole in mounting magnet utilizing a wood screw fastened to wooden support structures.

The present invention energizes almost any ferrous substrate using magnetic mounting means. The inventive apparatus can be used in conjunction with other appropriate ferrous fasteners to provide ease of installation in non-ferrous installations.

In the preferred embodiment, the sensory stimulation apparatus is powered by class “T” rated or “Tri-Path” or other amplifiers providing true sine wave amplified signal to the drivers. Bluetooth receivers provide connectivity to most smart devices. The inventive coil-driven driver produces true sine waves that are the only natural waveform. The use of this waveform in conjunction with sensory stimulation has been shown in clinical trials to have positive physiological and psychological effects for the viewer or listener.

The broadband aspect of the driver provides tactile, haptic, kinesthetic, and bone conduction sensory stimulation to enhance sensory immersion, and overcome mechanical hearing loss. The high fidelity, broadband, true waveform aspect of the inventive driver also provides sensory stimulation for artifacts such as the speeders in Star Wars movies or the F-15 cockpit in the movie, Top Gun. Musical sensory stimulation creates a live listening experience for concerts such as More Than a Feeling performed by the musical group, Boston.

Fidelity, bandwidth, scalability, mountability, and high force output garner unique device protection.

### BRIEF DESCRIPTION OF THE DRAWING

A complete understanding of the present invention may be obtained by reference to the accompanying drawing, when considered in conjunction with the subsequent detailed description, in which:

FIG. 1 is a schematic diagram of the sensory stimulation apparatus in accordance with the present invention;

FIG. 2 is a schematic connection diagram to illustrate connections used to operate the sensory stimulation apparatus; and

FIG. 3 is a photographic depiction of a handheld remote control device for controlling operations of the sensory stimulation apparatus.

### DETAILED DESCRIPTION OF THE PREFERRED EMBODIMENT

Although the following detailed description contains specific details for the purposes of illustration, those of ordinary skill in the art will appreciate that variations and alterations to the following details are within the scope of the invention. Accordingly, the exemplary embodiments of the invention described below are set forth without any loss of generality to, and without imposing limitations upon, the claimed invention.

A dual dome, coil driven sensory stimulation device or apparatus is provided to create vibration synchronized with a soundtrack to a listener. An amplifier can receive electrical signals from a sound generator and can apply an electrical signal to one or more drivers. Each driver is electrically connected to the amplifier and has a driving magnet, toroidal pole pieces, and a coil. The driver can be mounted to furniture.

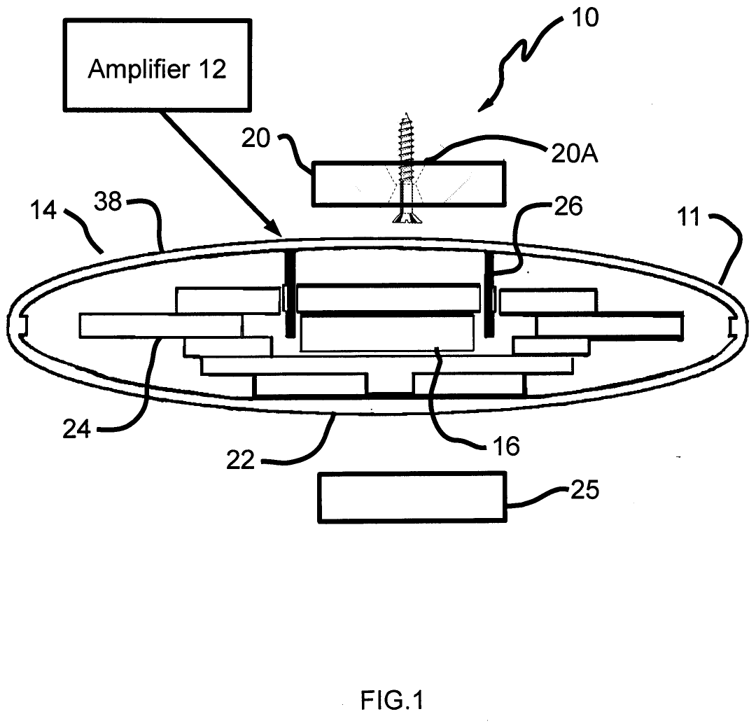

Referring now to FIG. 1, there is shown a schematic diagram of the sensory stimulation apparatus 10 in accordance with the present invention. Apparatus 10 is contained in a disc-shaped housing 11, comprising two dome-shaped portions which, when affixed to each other, form an effective mechanical spring that facilitates movement between a coil and magnet structure, the outer dimensions of assembled housing 11 being approximately 5″ in diameter and 1″ in height in the preferred embodiment.

Apparatus 10 consists of a Bluetooth-connected amplifier 12 and two magnetically mounted drivers 14 in the preferred embodiment. Only one driver 14 is shown in FIG. 1 for simplicity. Of course, a greater or a smaller number of drivers 14 can be used, as required. The watertight configuration of housing 11 facilitates use in pools, hot tubs, and bathtubs for high fidelity underwater sound and whole body immersion, sensory stimulation.

Apparatus 10 is supplied with all the necessary hardware for mounting driver 14 to wood via screws 20A and countersunk holes or to metal via at least one mounting magnet 20, also having countersunk holes. Driver 14 has a neodymium driver magnet 16 of 52 Gauss in the preferred embodiment, commercially available from multiple vendors. At the upper surface 18 of driver 14 is attached a mounting magnet 20 for attaching driver 14 to the frame of a chair, sofa, infant car seat, a gaming booth, a massage table, a pool, hot tub, bathtub, or bed frame, for example, not shown. Any other items of furniture can be used without departing from the scope of the invention. Similarly, driver 14 can be operatively connected to dance or stage flooring for performing musical bands. If attaching driver 14 to wood or other non-metal surface, mounting magnet 20 is first removed therefrom and the correct placement in furniture is determined by the user. Mounting magnet 20 has a countersunk hole that allows the use of standard wood screw 20A to attach to most wooden substrates. The placement should not interfere with any mechanical components of a chair or couch and sufficient clearance should be ensured between the bottom surface 22 of driver 14 and the floor. For best fidelity, driver 14 should not contact any other surface or the floor.

Magnet assembly 16 comprises toroidal pole pieces 24, of varied circumference and thickness and a cylindrical neodymium magnet 20, both of which are commercially available from multiple vendors. Toroidal pole pieces 24 are stacked to allow the greatest possible mass within housing 11 and increasing magnetic flux proximate a coil 26. Magnet 16 is preferably fabricated from rare earth magnet materials and are stacked cylindrical magnets in the preferred embodiment.

Coil 26 is a high density, high temperature coil such as manufactured by Precision Econowind Corporation.

Optionally, another externally-mounted permanent magnet 25 can be added to the lower portion of housing 11 to increase the magnetic flux of driver 14.

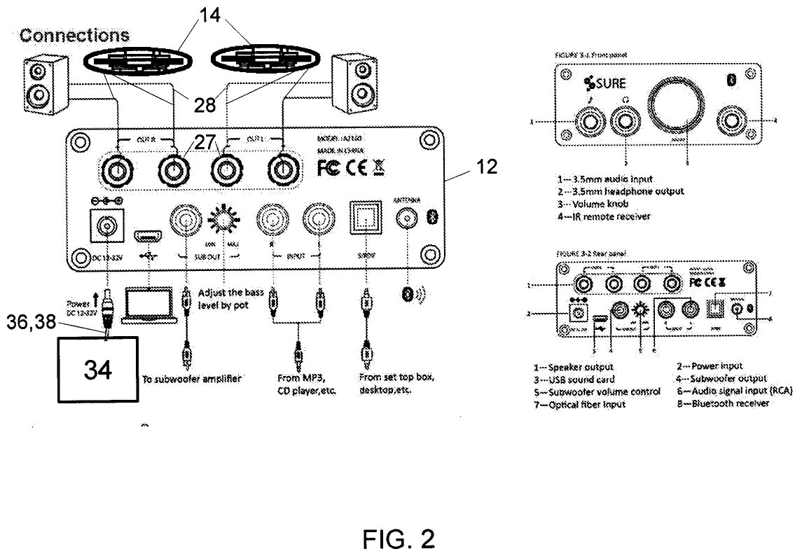

Referring now also to FIG. 2, there is shown a schematic connection diagram to illustrate connections used to operate sensory stimulation apparatus 10. Bluetooth-connected amplifier 12 has jacks 27 for connecting speaker wire plugs 28 and jacks 30 for receiving wires and plugs 32 from sound generators, such as stereo equipment, video players, TVs, MP3 s, PCs, and the like, not shown. It should be understood that speaker wires can be connected to speaker or sensory stimulation drivers 14, as shown.

Amplifier 12 is connected to a power supply 34 for ease of use; a 120 VAC power cord 36 is attached to power supply 34, as is a power cable 38 for amplifier 12. The low profile of amplifier 12 and power supply 34 allows the system to be hidden underneath furniture in most cases. Once one or more drivers 14 are mounted, they may be connected to amplifier 12 via speaker terminals, not shown. Speaker terminals are labeled with + and − indicia to show correct polarity for hook up. It is important that the correct polarity is applied to the wires to make sure that there is no phase cancellation between drivers 14.

Once all wiring connections are made, power cord 36 maybe plugged into any 120/230 VAC outlet, not shown. This supplies current to power supply 34 and then amplifier 12. Power supply 34 has a green light, not shown, in the preferred embodiment to indicate that it is powered on and amplifier 12 has a light, not shown, to indicate which input is selected.

In operation, volume controls 36 of amplifier 12 are used to change the magnitude of effect felt in furniture. Music players with active equalization are preferred, as this enhances the overall experience for different types of music.

The magnetic mounting via mounting magnets 20 in driver 14 (FIG. 1) facilitates correct volume levels by being noise free at correct levels and producing a rattling sound if over driven. This rattling is due to driver 14 being overpowered, which causes driver 14 to vibrate against the housing 11 thereof.

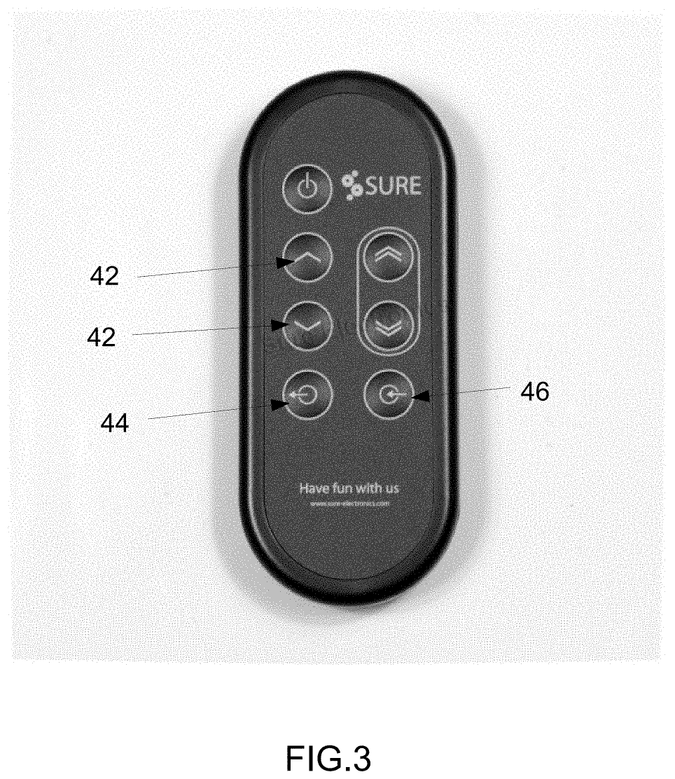

Referring now also to FIG. 3, a handheld remote control device 40 is shown. Volume controls 36 of amplifier 12 (FIG. 2) allow output levels to be changed. Front panel volume control 36 or up and down arrows 42 on the left side of remote control 40 can be used to change volume levels on amplifier 12. The lower left button 44 mutes the sound and the right bottom button 46 changes the equalization from a loudness contour flat to bass boost with successive button pushes.

### Music and Frequency Selection

Apparatus 10 can reproduce most music and healing frequencies as a true sine wave output. This high fidelity output means that listeners can now experience what the original performer experienced while playing the instrument, as driver 14 adds tactile, haptic, bone conduction, and audio to furniture, effectively recreating the vibratory signature of the instrument. The human voice, as an instrument, is also accurately reproduced to allow a listener to hear what the singer heard through bone conduction while performing. This is demonstrated by the “that's not my voice” perception when a person listens to only the recorded audio portion of his or her voice being played back.

It has been found that certain frequencies applied to a user have healthful effects. Many clinically identified healing frequencies are included, via download, for the system. These frequencies are accessed by clicking on the file name to automatically download to the music player.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a great number of variations of the devices, device components, and method steps set forth in the present description. As will be obvious to one of skill in the art, methods and devices useful for the present methods can include a great number of optional composition and processing elements and steps.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when compositions of matter are claimed, it should be understood that compounds known and available in the art prior to Applicant's invention, including compounds for which an enabling disclosure is provided in the references cited herein, are not intended to be included in any composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of,” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Having thus described the invention, what is desired to be protected by Letters Patent is presented in the subsequently appended claims.

What is claimed is:

1. A sensory stimulation driver to provide vibration synchronized with a soundtrack to a listener, comprising:
a) an amplifier comprising means for receiving electrical signals from a sound generator and means for applying an electrical signal to a driver;
b) a housing having outer boundaries and a cavity therein;
c) a driver disposed in the housing, the driver having an upper portion and a lower portion, the driver comprising a driving magnet extending a spaced apart distance from the outer boundaries of the housing, a coil, toroidal pole pieces surrounding the coil and disposed proximate the outer boundaries of the housing, the driver being electrically connected to the amplifier; and
d) at least one mounting magnet for mounting the upper portion of the driver to an object.

2. The sensory stimulation driver of claim 1, wherein housing is substantially watertight when assembled.

3. The sensory stimulation driver of claim 1, wherein mounting the sensory stimulation driver to a wooded substrate is accomplished by forming a center countersunk hole in the mounting magnet with a wood screw.

4. The sensory stimulation driver of claim 1, wherein the toroidal pole pieces are of varying diameters and stacked to allow the greatest possible mass within the housing and increasing magnetic flux proximate the coil.

5. The sensory stimulation driver of claim 1, wherein the magnet comprises rare earth magnet materials.

6. The sensory stimulation driver of claim 1, wherein the magnet comprises stacked cylindrical magnets.

7. The sensory stimulation driver of claim 1, wherein the outer dimensions of housing are approximately 5″ diameter and 1″ height.

8. The sensory stimulation driver of claim 1, wherein the furniture is selected from a group of furniture pieces consisting of: a chair, a sofa, an infant car seat, a gaming booth, a gaming booth, a massage table, a swimming pool, a hot tub, a bathtub, and a bed frame.

9. A transducer capable of converting electrical signals into mechanical vibration, the transducer comprising:
a) a housing comprising two geometrically similar dome-shaped halves wherein the first dome serves as a support structure for a voice coil and the second dome serves as a support structure for a permanent mounting magnet pole piece; and
b) means for affixing the dome-shaped halves to each-other to produce a watertight enclosure.

10. The transducer in accordance with claim 9, wherein vibration is produced thereby and synchronized with a soundtrack.

11. The transducer in accordance with claim 9, further comprising an amplifier operatively connected to the housing, the amplifier comprising means for receiving electrical signals from a sound generator and means for applying an electrical signal to a driver.

12. The transducer in accordance with claim 9, further comprising a driver disposed in the housing, the driver having an upper portion and a lower portion, the driver comprising a driving magnet extending a space apart distance from the outer boundaries of the housing, a coil, toroidal pole pieces surrounding the coil and disposed proximate the outer boundaries of the housing, the driver being electrically connected to the amplifier.

13. The transducer in accordance with claim 9, wherein the mounting magnet facilitates mounting the transducer to ferrous substrates using a mounting magnet having a countersunk hole.

14. The transducer in accordance with claim 13, wherein mounting the transducer to a wooded substrate is accomplished by forming a center countersunk hole in the mounting magnet with a wood screw.

15. The transducer in accordance with claim 12, wherein the toroidal pole pieces are of varying diameters and stacked to allow the greatest possible mass within the housing and increasing magnetic flux proximate the voice coil.

16. The transducer in accordance with claim 12, wherein the magnet comprises rare earth magnet materials.

17. The transducer in accordance with claim 12, wherein the magnet comprises stacked cylindrical magnets.

18. The transducer in accordance with claim 9, wherein the outer dimensions of housing are approximately 5″ diameter and 1″ height.

19. The transducer in accordance with claim 14, wherein the wooded substrate is selected from a portion of a group of furniture pieces consisting of: a chair, a sofa, an infant car seat, a gaming booth, a massage table, a swimming pool, a hot tub, a bathtub, and a bed frame.
